(19) United States
(12) Patent Application Publication
(10) Pub. No.: US 2024/0294839 A1
(43) Pub. Date: Sep. 5, 2024

(54) PROCESS OF TREATING CARBONACEOUS MATERIAL AND APPARATUS THEREFOR

(71) Applicant: SEATA HOLDINGS PTY LTD, Newcastle (AU)

(72) Inventor: John David WINTER, Glen Innes (AU)

(21) Appl. No.: 18/572,951

(22) PCT Filed: Jun. 23, 2022
(86) PCT No.: PCT/AU2022/050636

§ 371 Date: Dec. 21, 2023

(30) Foreign Application Priority Data
Jun. 23, 2021 (AU) 2021901894

(51) Int. Cl. C10J 3/72; C10J 3/12; C10J 3/22; C10J 3/84

(52) U.S. Cl. CPC C10J 3/721; C10J 3/12; C10J 3/22; C10J 3/84; C10J 2200/15; C10J 2300/093; C10J 2300/0986; C10J 2300/1618

(57) ABSTRACT

A process for processing carbonaceous material, the process comprising delivering a carbonaceous material to a first reactor zone; delivering a catalyst to the first reactor zone; processing the carbonaceous material within the first reactor to decompose and/or devolatilise at least a portion of the carbonaceous material; delivering an output from the first reactor to a secondary reactor; the secondary reactor having a higher temperature than the first reactor.

### TECHNICAL FIELD

This disclosure relates to processes for treating carbonaceous material, and particularly coal, in a reactor.

### BACKGROUND ART

Pyrolysis reactors provide thermochemical decomposition of organic material at elevated temperatures in the absence of oxygen or any halogen. Pyrolysis involves the simultaneous change of chemical composition and physical phase, and is irreversible. Reactor design can use two main modes of heat transfer to provide the energy for thermo-chemical conversion, direct, indirect or a combination of both. Indirect heating relies on metallic heat transfer surfaces, which is the limiting factor for scale-up of this type of equipment, resulting in multiple units operating in parallel to achieve reasonable plant through-put. This results in high capital cost, high maintenance cost, high operating cost and low thermal efficiency. Examples of this type of equipment are rotary kilns, drum kilns, retorts (fixed bed), auger, ablative and vacuum reactors. Some novel indirect heating methods include electrical (radiant and/or conduction), plasma, microwave and solar energy. These methods typically require cheap electricity and an inert carrier gas. Furthermore, these complex heating methods have high operational and capital cost.

Direct heat transfer can be achieved using a stream of hot spent combustion gases or recirculation of an inert gas (usually syngas). Using hot spent combustion gases causes significant dilution of the syngas with carbon dioxide and nitrogen, resulting in a very low calorific syngas that has limited uses because once cooled down it does not have sufficient fuel value for self-combustion. Using recirculation of syngas has the disadvantage of the off-gas cleaning system needing to be much larger to handle the extra recirculating gas volume and the gas must be re-compressed. In addition, the pyrolysis off-gas (raw syngas) must be wet scrubbed (cooled) to condense and remove the tars and oils. Therefore, the recycled gas must be re-compressed and re-heated from about 80° C. to +800° C. on each cycle, resulting in low thermal efficiency and high operating cost. In addition, the recirculating syngas must be re-heated using an indirect heat-exchanger, resulting in higher capital cost. High gas flow through the pyrolysis reactor decreases the yield of biochar. Examples of this technology are fixed bed retorts, multi-hearth furnaces, fluid beds and entrained flow reactors.

The above references to the background art do not constitute an admission that the art forms a part of the common general knowledge of a person of ordinary skill in the art. The above references are also not intended to limit the application to actuators, methods of fabrication of an actuator and its composition as disclosed herein.

### SUMMARY

The disclosure relates to processing of carbonaceous material in general, including coal, in a reactor. It should also be appreciated that the process disclosed may find application with other carbonaceous materials.

In some forms, the process is utilised to treat organic material using pyrolysis to deconstruct the organic material feedstock to base components. In some forms, the process is a low thermal cost treatment of organic material including recovery of some of the products or outputs of the treatment, such as carbon.

However, it will be appreciated that the process is not limited to these uses or outputs. The process described handles variability in feedstocks and can operate over a wide range of conditions.

In some forms the primary reactor may need to operate at higher temperatures i.e. to process high fixed carbon feedstocks such as coal. A vertical orientation using steam fluidization can achieve this at scale using our method of heat and mass transfer and in particular using multiple points of injection.

In some forms, the disclosed technology may leave a controllable portion of the carbon as a solid (char), that can be sequestered as a solid material to achieve carbon neutrality. In some forms, keeping a portion of the carbon as a solid also allows the syngas composition, in terms of H₂ to CO ratio, to be manipulated to suit downstream upgrading processes. For example, in some forms the technology and process allow a user to make methane if the H₂:CO ratio required is 3:1 or methanol if the H₂:CO ratio is preferably 2:1.

The disclosed system can also be manipulated by modifying the heat and mass transfer (HMT) media composition by blending reactive (iron based minerals) and non-reactive minerals (zeolite, alumina, etc.). This effectively shifts where the CO₂ reports to, i.e. moves from the syngas to the fluid bed oxidation off-gas. Using a reactive media (mass transfer) means no fuel is required for re-heating, i.e. FeO oxidizing to Fe₂O₃ provides sufficient energy with no CO₂ generation as a result. In some forms, the disclosed technology may have a combination of thermal and chemical looping principles, and may provide optimum pyrolysis and gasification outcomes, i.e. high yield of quality biochar and clean syngas not diluted with atmospheric nitrogen are obtained.

Being based on chemical looping, in some forms, separation of oxygen from air may not be required, this may potentially save electrical energy while producing similar syngas quality as conventional oxygen blown gasifiers.

In some forms the media may be a solid-state heat and oxygen carrier that may be recirculated (looping) within the process. In some forms naturally occurring minerals such as ilmenite or Iron ore may be ideal for this duty.

In some forms Syngas recovered may be used for generation of electricity (on-demand) or may be separated into products (i.e. hydrogen) or may provide chemical feedstock for conversion into other commodities. In some forms the syngas is not diluted with nitrogen, the calorific value is high, this may allow economical storage of the syngas (either in gas-holders or as compressed gases).

### BRIEF DESCRIPTION

Notwithstanding any other forms that may fall within the scope of the process and apparatus as set forth, specific embodiments will now be described, by way of example only, with reference to the drawings in which:

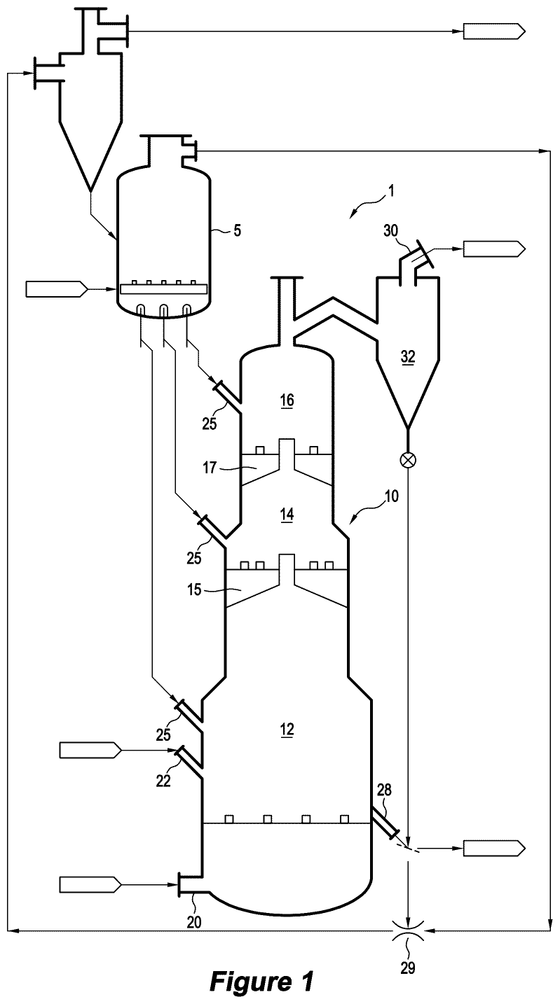

FIG. 1 shows a plan view of one embodiment of a reactor for use in treatment of carbonaceous material;

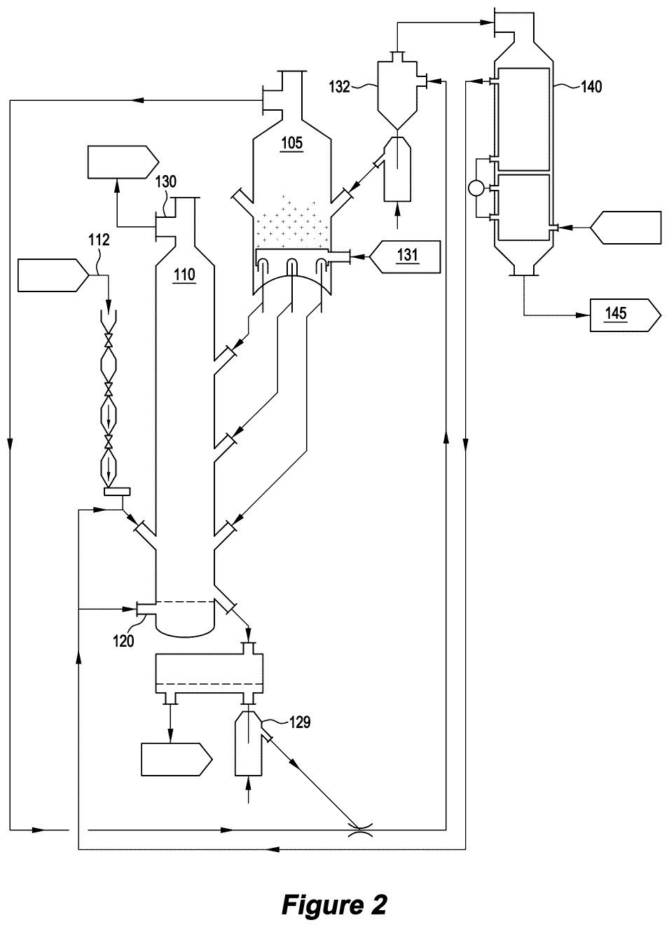

FIG. 2 shows a plan of a gasification plant incorporating the reactor of FIG. 1;

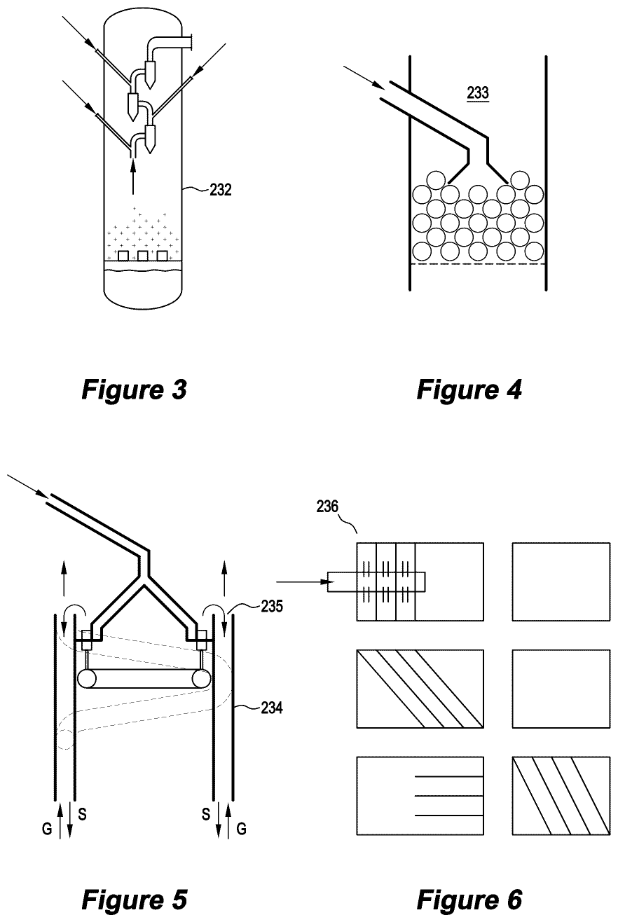

FIG. 3 shows an internal cyclone of one embodiment of the disclosure;

FIG. 4 shows a fluid bed design of one embodiment of the disclosure;

FIG. 5 shows a hot sand distributor of one embodiment of the disclosure;

FIG. 6 shows a hot sand distributor including lamellar plates of one embodiment of the disclosure;

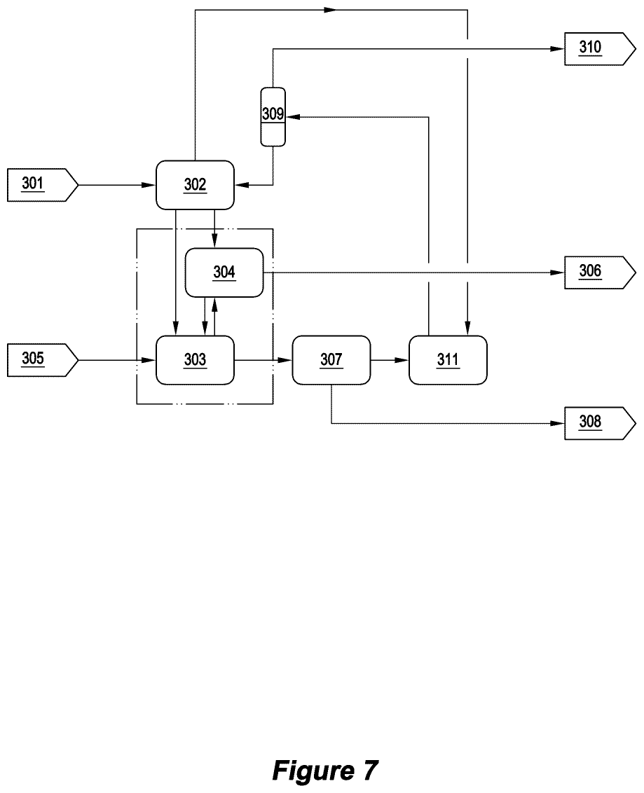

FIG. 7 shows a flow chart of one embodiment of a reactor wherein a primary and secondary reactor are arranged into a single vessel (reactor) for use in treatment of carbonaceous material;

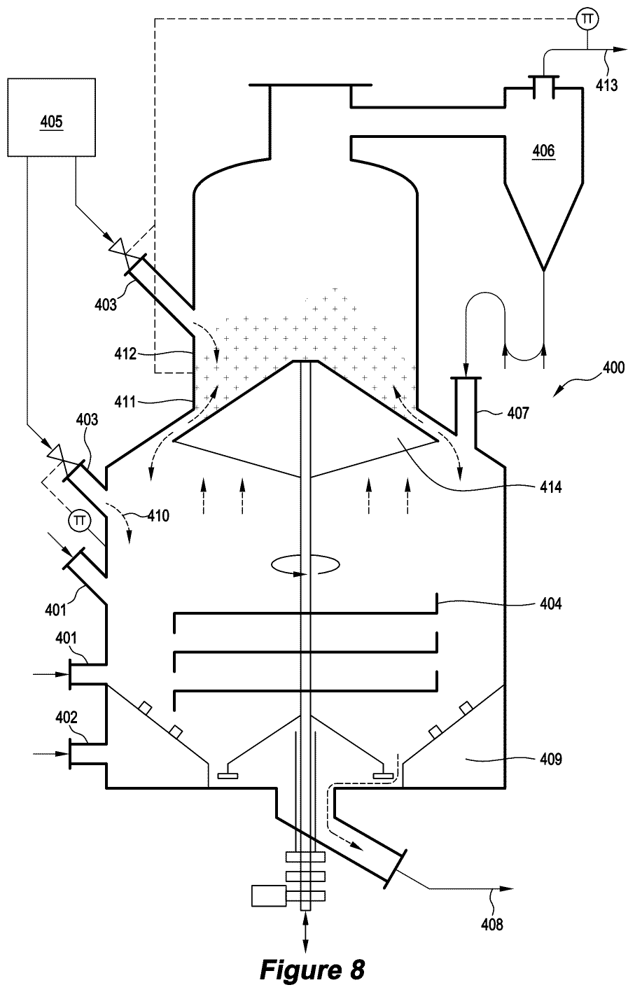

FIG. 8 shows one embodiment of a reactor wherein a primary and secondary reactor are arranged into a single vessel (reactor) for use in treatment of carbonaceous material.

### DETAILED DESCRIPTION

According to a first aspect, disclosed is a process for processing carbonaceous material, the process comprising delivering a carbonaceous material to a reactor; delivering a catalyst to the reactor; processing the carbonaceous material at a relatively low temperature within the reactor to deconstruct the carbonaceous material to base compounds. In some forms the reactor includes a vertical reactor having independent zones. In some forms the zones act as independent reactors. In some forms the zones are located or stacked vertically with respect to one another within the reactor.

The process in some forms is based on direct heat transfer using hot solids. In some forms a free flowing sand-like material is heated separately and then mixed together with the carbonaceous material or feedstock in the pyrolysis reactor. This method may have the advantage of supplying heat indirectly from the heat source (but directly to the feedstock) without dilution of the syngas with nitrogen or carbon dioxide.

In some forms the feed system for the carbonaceous material is mechanical. In some forms the mechanical feed system is flow based. In some forms the flow in the mechanical system is gravity based.

In some forms the primary reactor includes a material mixing system. In some forms this mixing system is in the form of lamella plates. In some forms this mixing system is in the form of an internal cyclone.

In some forms, the process further comprises recovering at least a portion of the catalyst from the output material and regenerating the catalyst for re-use in the process.

In some forms the output material includes biochar.

In some forms the catalyst comprises an iron oxide based catalyst. In some forms the catalyst comprises ilmenite.

In some forms the catalyst or heat transfer media can contain a reacting component or absorbent. In some forms the absorbent comprises calcium oxide.

In some forms the process further comprises the step of recovering syngas from the output material of the reactor processing.

In some forms the reactor forms part of a gasification plant including a fluid bed oxidation reactor for sand or catalyst. In some forms the reactor includes a submerged plenum. In some forms the reactor is in communication with the fluid bed.

In some forms the temperature of operation of the primary reactor is between 800 and 900 degrees C. In some forms the temperature of operation of the secondary reactor is between 950 and 1000 degrees C.

In some forms steam is used as a fluidising agent for the reactor. In some forms steam is fed from the bottom of a vertical reactor to fluidise the biomass before reaction.

Also disclosed is a process of treating carbonaceous material, the process comprising treating carbonaceous material in a low temperature reactor with an iron based catalyst.

Heat transfer is achieved using a free-flowing solid material, i.e. sand like material that is recirculated between a fluid bed at 950° C. or a similar temperature and the pyrolysis unit operating at an exit temperature of about 500° C. An example of the heat transfer media that may be used is ilmenite.

The reactor may include multiple points of hot sand injection into the reactor which may have the benefit of providing controlled slow autogenous pyrolysis which provides maximum temperature control for improved yield of char, syngas and removal of contaminates. In some forms a hot sand distribution assembly is used which delivers hot sand to a series of spaced apart inputs in the reactor. The hot sand distribution assembly may comprise a single hot sand input and a plurality of outputs which may be controlled through adding sufficient fluidised air to decrease the density in a riser chamber and move the hot sand into the plurality of outputs.

The reactor may in some forms use a catalytic sand material or thermal treatment of minerals to provide an additional product stream.

In some forms the reactor is mechanically agitated to achieve good mixing, even temperature, good residence time control and avoid blockages. Partial fluidisation with recycling of a portion of the syngas can assist temperature control and material movement through the reactor and enhance resultant biochar properties. The process may have the benefit that scale-up of the pyrolysis reactor is only limited by mechanical design—not heat transfer area.

Recycling of the spent sand may be achieved using special elevators or pneumatic transfer without requiring the sand to be cooled.

Waste energy from re-heating of the sand may in some forms be used to dry the incoming biomass feed which maximises the thermal efficiency and increases the syngas quality.

In some forms the primary and secondary reactors may be arranged into a single vessel (the two unit operations within the dashed box as shown in FIG. 7). In some forms steam derived from high moisture feedstocks, e.g. biosolids, algae feedstocks, etc. is used to provide “self-fluidisation”. In some forms steam or recycle syngas can be injected to assist mixing and/or help sweep pyrolysis gases into the secondary reactor for the complete thermal decomposition.

The advantages of this technology may include:
High energy efficiency, as all waste heat is utilised for pre-drying of the feed biomass and/or combustion air pre-heating
High yield of biochar due to favourable reactor conditions (slow pyrolysis)
Control of the biochar properties (to allow sale to different applications)
Some oils and tars will be present in the raw syngas, which is treated in a separate gasifier reactor, also using hot sand, to convert these oils and tars to more syngas, therefore no by-products to deal with and no odours.
Pyrolysis gas is not diluted by any inert gas or combustion products.
Good steady state control of process conditions, temperature, residence time with no hot or cold spots, therefore more consistent product quality.
Able to process a wide range of feedstocks types and sizes without risk of plugging gas flows or blockage
Easy start-up and shut-down (no consequence if the plant needs to be stop suddenly, i.e. oil and tar condensation in pipework)
Simple/easy to maintain equipment
Can use catalytic materials to assist pyrolysis and lower emissions
Part of the product biochar may be utilised for syngas cleaning (like activated carbon) and then returned to the system for treatment
Safe operation, low fugitive emissions
In some forms, the system may have the benefit of using a fifth or even a tenth as much length in a reactor.
The syngas output may be clean and clear of nitrogen as no nitrogen is added to the system.
The cleaned syngas (not diluted with nitrogen) may have the high calorific value, this may allow economical storage of the syngas (either in gas-holders or as compressed gases).
In some forms, separation of oxygen from air may not be required, this may save electrical energy while producing similar syngas quality as conventional oxygen blown gasifiers.

Referring now to FIG. 1, disclosed is a processing assembly 1 which includes a first fluid bed 5 and a reactor 10. The first fluid bed 5 is configured for oxidation at a temperature of approximately 1100 degrees C. The reactor 10 is vertically oriented and has a height greater than its width. In some forms the reactor has a width at its base that is greater than the width at its upper region.

The reactor 10 includes a primary reaction zone 12 which comprises a second fluid bed and is configured for gasification having an operation temperature for gasification of between 800 and 900 degrees C. The primary reaction zone in the illustrated form has a larger diameter than the remainder of the reactor 10. A secondary reactor zone 14 is located above the primary reactor zone 12 and is separated from the primary reactor zone 12 by a separator 15 which extends from the wall of the reactor and includes a centrally located cavity. The secondary reactor zone has an operating temperature of approximately 950 degrees C. The secondary reactor zone 14 is separated from a tertiary zone 16 with a temperature of approximately 1000 degrees C. located at an upper end of the reactor 10. The secondary and tertiary reaction zones are separated by a separator 17. The primary and secondary reaction zones are designed to be independent of one another while incorporated into the body of the reactor. Steam is injected at a lower port 20 located toward the lower end of the reactor and opening into the primary reaction zone. Coal or other carbonaceous material is injected at a second port 22 located within the primary reaction zone.

The steam moves upward through the reactor. Because there are no mechanical/moving parts within the reactor, higher temperatures may be allowed than is possible in other reactors.

Catalyst material in the form of a hot sand-like material is injected to the reactor at multiple injection points 25. Gravity is used to distribute the hot sand to the multiple injection points in this case, which is driven by the need to have a higher hot sand temperature when dealing with high fixed carbon content feedstocks (coal). Air can be used to lift the spend sand back up to the fluid bed oxidation stage.

In some forms the sand contains iron bearing minerals, such as ilmenite. Operating under these conditions, a majority of the energy required for re-heating the sand can be derived from re-oxidation of ferrous iron to ferric iron oxide (4FeO+O₂→2Fe₂O₃). Conversely, this delivers oxygen to the gasification reactions.

Shown is a combined bubbling/turbulent fluid bed reactor for gasification and partial entrained flow along with a turbulent fluid bed reactor for secondary gasification of tars. This increases the gas velocity and temperature as syngas moves through the reactor.

In some forms the resultant raw syngas comprises a tar-free syngas which in some forms allows heat to be recovered prior to water quenching. The heat may be utilised for generation of steam.

In some forms char and ash are released from the reactor at an outlet 28. Off-gas or air may be returned to fluid bed 1 at 29. Raw syngas is released at 30 and a cyclone 32 is utilised for delivery.

In some forms the HMT mixture of solids is provided to allow capture of contaminants within the first fluid bed. In some forms the system may be retrofitted to a reactor.

Referring now to FIG. 2, disclosed is a gasification plant including a vertical reactor 110 as broadly described in relation to FIG. 1. The vertical reactor includes primary and secondary reaction zones located vertically with respect to one another.

Solid fuel is injected to the reactor 110 at 112. The solid fuel may be in the form of biomass and coal and sufficient to neutralise some or all CO₂ emissions.

Super critical steam is injected at lower port 120 and moves upwardly within the reactor 110.

Raw/hot syngas exits at outlet 130. A fluid bed 105 delivers catalytic material which may be in the form of a hot sand to the reactor 110. Air is injected to the fluid bed at 131. A cyclone 132 delivers material to the fluid bed 105.

The system further includes a heater 140 which boils water or other material. In the illustrated form the heater produces steam for delivery to the reactor 110. The heater comprises a boiler and a super heater. Off gas from the heater is delivered at 145 to a filter or wet scrubber.

Char and ash is delivered from the reactor at 129.

FIGS. 3 through 6 show forms of a mixing system inside the reactor.

FIG. 3 shows an internal cyclone 232. FIG. 4 shows a structured packing 233 which relies on distribution of hot sand. FIG. 5 shows a multi start helix 234 having a sawtooth edge 235 for better hot sand distribution. FIG. 6 shows lamella plates 236 with switch back arrangement. The flow rate of hot sand can be varied to change the gas flow. In alternative embodiments the system could include multiple aspects for example, structural packing then cyclones. Seal pots may be built on the sidewalls to make measurements of TT, PT possible.

In some forms a solid contacting method is used.

Referring to FIG. 7, air from the source 301 is injected to the fluid bed 302. The fluid bed is configured for oxidation at a temperature of approximately 1000-1100 degrees C. Primary reactor zone 303 (pyrolysis) and secondary reactor zone (gasification) 304 are in communication with the fluid bed 302. Hot media from the fluid bed is injected into primary reactor zone 303 and secondary reactor zone 304. Clean and clear hot syngas 306 not diluted with atmospheric nitrogen exits through an exit port in the secondary reaction zone. A separator 307 is configured to separate excess char 308. Warm off-gas 310 exits the system. The media is a solid state heat and oxygen carrier that is recirculated (looping) through a pre-heater or lifter 311 within the process to the fluid bed oxidation stage.

Referring now to FIG. 8, in some forms disclosed is a primary and secondary reactor arranged into a single vessel 400 (reactor). This correlates with the unit operations within the dashed box on the process flowsheet shown in FIG. 7. In some forms steam derived from high moisture feedstocks, e.g. biosolids, algae feedstocks, etc. may be used to provide “self-fluidisation”. Alternatively steam or recycled syngas can be injected to assist in mixing and/or to help sweep pyrolysis gases into the secondary reactor for complete thermal decomposition. In some form the reactor 400 may include multiple injection points/ports to inject feed stock which may include high moisture feed stocks, steam or recycle syngas or other feed stocks. In some forms the Co-feeding may be used to manage energy.

In FIG. 8, the vertical reactor 400 includes primary 410 and secondary reaction 412 zones located vertically with respect to one another. The primary reaction zone in the illustrated form has a larger diameter than the remainder of the reactor 400. A secondary reactor zone 412 is located above the primary reactor zone 410. In some forms the reactor zones are separated by a gap, by a valve or by a multi start helix 411 having a sawtooth edge 414 shown in FIG. 8. The secondary reactor zone 412 has an operating temperature of approximately between 750-950 degrees C. The primary reactor zone 410 has an operating temperature between 350-600 degrees C. In some forms the primary reactor includes a material mixing and/or stirring system 404. In some forms this mixing and/or stirring system is in the form of lamella plates. In some forms this mixing and/or stirring system is in the form of an internal cyclone.

Feed stock, which may include high moisture feedstock, is injected into the reactor at the primary reaction zone through port 401. Alternatively steam or recycled syngas can be injected at a lower port 402 located toward the lower end of the reactor and opening into the primary reaction zone to assist mixing and/or help sweep pyrolysis gases into the secondary reactor for complete thermal decomposition. The steam moves upward through the reactor. In some forms sweep gas may be injected at a lower port 402.

In some forms, alternative feedstock which may include coal or other carbonaceous material is fed in to the reactor through port 401. Some forms may handle variability in feedstocks and can operate over a wide range of conditions.

In some forms the primary and secondary reactor zones are in communication with the fluid bed 405. In some forms a height adjustable hot media injection port may be used to inject hot media from the fluid bed 405 that is configured for oxidation at a temperature of approximately 1000 degrees C. into primary and secondary reactor zones. In some forms the hot media may be catalytic material. In some forms, the reactor shown in FIG. 8 is a combined turbulent/fluidised bed reactor and self fluidised reactor. In some forms the ports may be in the form of a nozzle.

A separator 409 is configured to separate excess char and/or ash. Char and/or ash is delivered from the reactor at 408. In some forms char may be a bio char. Clean and clear hot syngas exit through port 413 and a cyclone 406 is utilised for delivery. In some forms adjustable gap 407 may be used to maintain reactor height.

It will be understood to persons skilled in the art that many other modifications may be made without departing from the spirit and scope of the process, and apparatus as disclosed herein.

In the claims which follow and in the preceding description, except where the context requires otherwise due to express language or necessary implication, the word “comprise” or variations thereof such as “comprises” or “comprising” is used in an inclusive sense, i.e. to specify the presence of the stated features but not to preclude the presence or addition of further features in various embodiments of the process and apparatus as disclosed herein.

1. A process for processing carbonaceous material, the process comprising:
delivering a carbonaceous material to a first reactor zone;
delivering a catalyst to the first reactor zone;
processing the carbonaceous material within the first reactor to decompose and/or devolatilise at least a portion of the carbonaceous material;
delivering an output from the first reactor to a secondary reactor;
the secondary reactor having a higher temperature than the first reactor.

2. The process according to claim 1, wherein the temperature within the first reactor is between 800 and 900° C.

3. The process according to claim 1, wherein the reactor includes at least two zones which are vertically separated from one another.

4. The process according to claim 1, wherein the catalyst comprises an iron oxide based catalyst.

5. The process according to claim 4, wherein the catalyst comprises ilmenite.

6. The process according to claim 1 comprising delivering the catalyst in the form of hot sand or other solid media in the form of sand.

7. The process according to claim 6, wherein the catalyst is delivered through a plurality of inputs spaced apart along a height of the reactor.

8. The process according to claim 7, wherein the delivery of the catalyst into the reactor through the plurality of spaced apart inputs is controlled by a plurality of valves.

9. The process according to claim 8, wherein the valves are non-mechanical.

10. The process according to claim 7, wherein delivery of the catalyst at various points along the length of the reactor divides the reactor into reaction zones.

11. The process according to claim 1, wherein the catalyst is delivered through a hot sand distribution assembly comprising a plurality of inputs into the reactor, the inputs being controlled through adding fluidised air to the assembly to decrease the density in a riser chamber and move the hot sand into the plurality of inputs.

12. The process according to claim 1 wherein the carbonaceous material comprises coal.

13. The process according to claim 1, wherein the output delivered to the secondary reactor comprises a gaseous output.

14. The process according to claim 1, further comprising separating biochar from the output material.

15. The process according to claim 1, wherein the output is a syngas output from the reactor.

16. The process according to claim 13, wherein the secondary reactor and the reactor use a common recirculated media.

17. The process according to claim 1, further comprising delivering additional catalyst to the secondary reactor.

18. The process according to claim 1, further comprising recovering a solid carbon-based material.

19. The process according to claim 1, wherein steam is utilised as a fluidising agent.
